(19) United States
(12) Patent Application Publication
(10) Pub. No.: US 2006/0067572 A1
(43) Pub. Date: Mar. 30, 2006

(54) Object imaging system

(75) Inventors: Timothy White, New Boston, NH (US); John Merva, Weare, NH (US); Brian St. Pierre, Howell, MI (US)

Correspondence Address: BOURQUE & ASSOCIATES, P.A., 835 HANOVER STREET, SUITE 303, MANCHESTER, NH, 03104, US

(73) Assignee: Tattile, L.L.C., Bedford, NH (US)

(21) Appl. No.: 11/226,164

(22) Filed: Sep. 14, 2005

Related U.S. Application Data
(60) Provisional application No. 60/609,898, filed on Sep. 14, 2004.

(51) Int. Cl. G06K 9/00; G06K 9/36

(52) U.S. Cl. 382/152; 382/286

(57) ABSTRACT

A system, method, and device for imaging and identifying attributes of an object are disclosed. The exemplary system may have the following components. A retro-reflective panel may be positioned behind the object. A light source may be used to illuminate the retro-reflective panel and the object. A camera may image light reflected by the retro-reflective panel and the object. A microprocessor may receive the images from the camera and identify attributes of the object.

### CROSS-REFERENCE TO RELATED APPLICATIONS

The present application claims priority from U.S. provisional patent application Ser. No. 60/609,898, filed Sep. 14, 2004, by Timothy P. White, incorporated by reference herein and for which benefit of the priority date is hereby claimed.

### TECHNICAL FIELD

The present invention relates to an imaging system and more particularly, to a device, method, and system for imaging objects and providing dimensions of an object.

### BACKGROUND INFORMATION

Manufacturing centers and shipping centers often need to determine attributes of objects in order to perform a desired task on an object. These centers often use automated production lines to perform the desired tasks on the objects. The objects may often be moved by conveyer belts or actuators from one processing point to another along the production line. In order to maintain the rate production for the automated production line it may be desirable to rapidly determine the desired attributes of the object. It also may be desirable to determine the desired attributes with minimal manipulation of the object.

For example, a shipping center may need to determine the volume of rectangular packages in order to determine the cost of shipping and the amount of space required to ship each package. The packages may come in a variety of shapes and sizes. The shipping center may need to rapidly determine the size and shape of the package as the package is processed for shipping. In addition, the package may not be perfectly aligned from a point of reference relative to a device determining the measurements. The shipping center may need to determine the measurement without centering each package to the point reference. The packages may also come in a variety of colors with a variety of tags on the surface of the packages. The shipping center may need to determine the profile of the packages without errors caused by color or tags on the exterior surface of the package.

Accordingly, a need exists for a device, method, and system for rapidly determining attributes of objects. The attributes may need to be determined without regard to the orientation. The attributes also may need to be determined without regard to the color, print, or shade of the exterior surface of the object.

### SUMMARY

The present invention is a novel device, system, and method for determining attributes of the object. An exemplary embodiment, according to the present invention, may have a retro-reflective panel positioned behind the object. The system may have a light source illuminating the retro-reflective panel and the object and a camera imaging light reflected by the retro-reflective panel and the object. The system may also have a microprocessor that receives the images from the camera and identifies attributes of the object.

Embodiments may include one or more of the following. The attributes are a width and a depth of the object or other dimensions. The system may also have a sensor for determining a height measurement of the object. The microprocessor may determine the volume of the object based on the height, width, and depth. The camera may be centered over the retro-reflective panel. The system may also have a protective, translucent layer covering the retro-reflective panel. The light source may provide near-infrared light energy. The microprocessor may determine two or more edge points to determine a line to identify an edge of the object. The microprocessor may perform image-processing techniques on the images. The camera may be a video camera taking multiple images of the light reflected by the retro-reflective panel and the object. The microprocessor may also utilize the multiple images to reduce errors in identifying attributes of the object.

In an alternative embodiment, the exemplary method for determining attributes of the object may reflect light from a retro-reflective panel and an object. The method may also image the light reflected by the retro-reflective panel and the object with a camera. The method may use the images to identify attributes of the object by processing the imaged light with a microprocessor.

It is important to note that the present invention is not intended to be limited to a system or method which must satisfy one or more of any stated objects or features of the invention. It is also important to note that the present invention is not limited to the exemplary embodiments described herein. Modifications and substitutions by one of ordinary skill in the art are considered to be within the scope of the present invention, which is not to be limited except by the following claims.

### BRIEF DESCRIPTION OF THE DRAWINGS

These and other features and advantages of the present invention will be better understood by reading the following detailed description, taken together with the drawings herein:

FIG. 1 is a system diagram of a retro-reflective exemplary embodiment 100 according to the present invention.

FIG. 2 is an observation stage 104 according to the present invention.

FIG. 3 is an illustration of the light rays reflected by the observation stage and the object according to the present invention.

FIG. 4 is a system diagram of a multiple camera exemplary embodiment 400 according to the present invention.

FIG. 5 is a system diagram of a patterned observation stage exemplary embodiment 500 according to the present invention.

FIG. 6 is the patterned observation stage 500 according to an exemplary embodiment of the present invention.

### DETAILED DESCRIPTION

The invention provides attributes of an object. The object may be, for example, a package being processed for shipping or a part used in an assembly or manufacturing process. The object is moved to the inspection area. The inspection area may have an observation stage. A camera may be used to detect reflected light from the observation stage. The reflected light may be analyzed to determine various attributes of the object in the inspection area. Examples of the attributes may include, for example, measurements, dimensions, or the profile of the object.

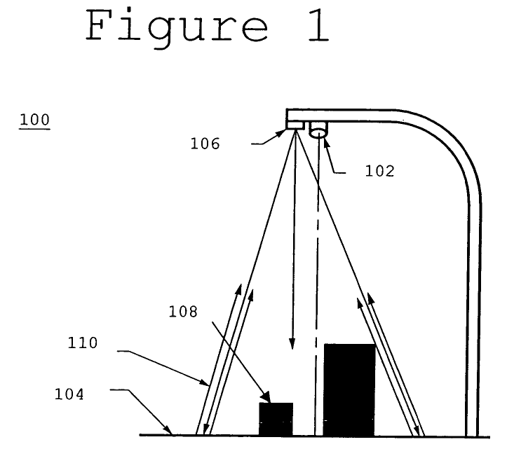

Referring to FIG. 1, a retro-reflective exemplary embodiment 100 utilizes a camera 102 and a measuring sensor (not shown). The camera 102 and measuring sensor are aligned vertically over the center point of an observation stage 104. A light source 106 may be positioned immediately adjacent to the camera 102 so that it can illuminate the entire observation stage 106.

The camera 102 may be a variety of light-detecting apparatuses known in the art. The light source 106 may be positioned to direct light at the observation stage 104 to cause the light to reflect from the observation stage 104 directly back at the camera 102. The light source 106 may be in the near-infrared spectrum so that it is not visible to the users of the system, while being near the most sensitive part of the acceptance spectrum of the camera 102. In addition, utilizing lighting outside the visible spectrum may also minimize the interference that may be caused by ambient lighting. A filter may also be applied to the camera limiting the wavelength of light entering the camera to those wavelengths output by the light source.

According to the retro-reflective exemplary embodiment 100, a light retro-reflective pattern may cover at least part of the observation stage 104. The retro-reflective pattern may have an optically textured surface to reflect light from the light source 106. The patterned surface may be a retro-reflective pattern, capable of focusing reflected light 110 to a determined location.

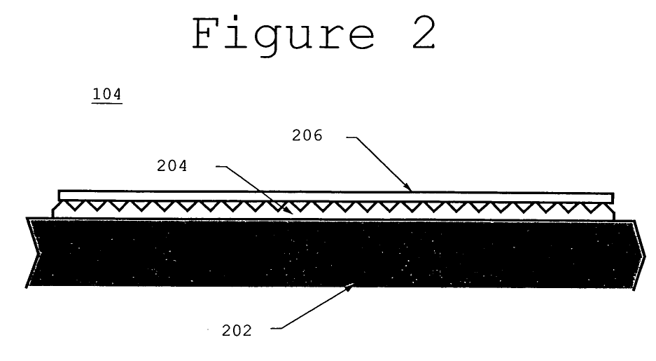

Referring to FIG. 2, the observation stage 104 may be constructed of a countertop 202 with a retro-reflective material 204, which serves to reflect the light back to the light source/camera lens. The optical retro-reflective pattern of the retro-reflective material 204 may be made up of an array of solid prisms or hollow reflective cavities. Each cavity or facet may have the shape of a corner of a cube such that an optical ray entering a prism or cavity unit undergoes two or more reflections. The first reflection directs the light to another facet. The final reflection sends the ray back substantially parallel to the original path of entrance. Illuminating a retro-reflective panel with a point light source will cause the light striking the panel to reflect backward and be refocused on or near the immediate vicinity of the light source and the camera. An example of the retro-reflective material is manufactured by 3M™ under the brand name Scotchlite™. The retro-reflective material is not limited to utilizing a corner cube reflector. Other geometries and techniques may be used to provide the retro-reflectivity.

The precise geometry and size of the retro-reflective facets or cavity is related to their efficiency, cost and functionality. The geometry may not need to reflect light precisely parallel, such as a reflective vast. At the other end of the spectrum, corner cubes can be made precisely enough so that an array of them placed on the moon causes laser beams directed at them from Earth to be exactly reflected back to the laser. The precision of the facets may be designed based on the clarity needed to determine the desired attributes of the object. The facets may also be designed to reflect the light a predetermined distance or to a predetermined spot. For example, the corner cube reflectors built into the red tail lights of cars would be useless if they reflected light back at the headlights on the car behind them, so the corner cube geometry is adjusted to cause the reflection geometry to expand into a cone sufficient to reach the eyes of the driver in the car behind. Similarly, the facets may be designed to reflect and focus light to a camera lens based on the location and direction of the source of light and the camera.

According to one exemplary method of construction, the retro-reflective material is adhered to the countertop 202. A layer of scratch resistant material 206 may cover the retro-reflective material 204. The scratch resistant material may be, for example, glass or hard plastic. The total thickness on the observation stage 104 may be in the range of one to four millimeters (mm).

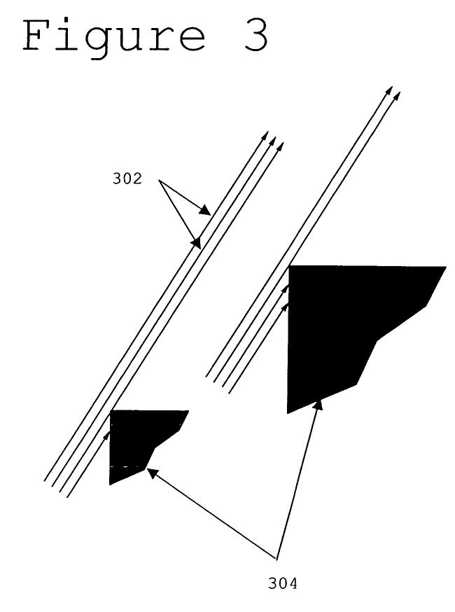

Referring to FIG. 3, the light impinging on the retro-reflective observation stage 104 from the light source 106 is reflected exactly back toward the camera 102, with adjacent light rays 302 being essentially parallel. Because the returning light rays are aimed back at their source, such retro-reflective material appears thousands of times brighter to the camera than a perfect diffuse white material. Hence, even a low-power light source can cause the observation stage 104 to appear bright white, and any object 304 on it to appear black, even if such objects are themselves painted white. In addition, light rays ascending by the corners of two different sized objects from the retro-reflective material result in the edges of the objects being in focus, regardless of the objects' height.

The camera 102 may be positioned to gather data associated with the light pattern produced by the light source on the observation stage 104. In one example, the light source is positioned over the inspection area and the camera is positioned at about at least a thirty-degree angle above the plane in which the observation stage lies. In another example the point source of light is located within the camera lens. The light from the point source is focused directly back at the lens of the camera. The camera may be a video camera or other camera to allow for continuous collection of image data. The image data may be stored and processed to determine measurement information for the object, as will be discussed later herein.

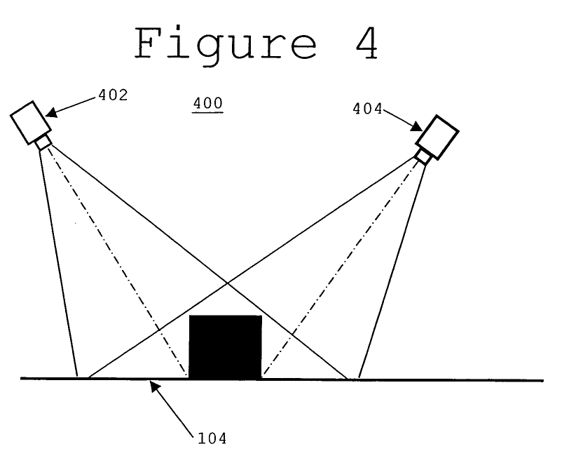

Referring to FIG. 4, multiple cameras may be employed to obtain the object attribute. In this multiple camera exemplary embodiment 400, a first camera 402 and a second camera 404 may be used to obtain images of the object on the observation stage 104. The images may be combined to provide a more accurate overall image of the object. For example, the images are overlapped and image processing is used to identify the edges of the combined images. The images may also be used independently to provide separate details regarding the object. For example, the first camera 402 may be used to provide edge details for edges facing towards the first camera 402 while the second camera 404 is used to provide edge details for edges facing the second camera 404. The information regarding these edge details may be combined to provide an overall edge profile of the object.

The position of the light source 106, camera 102, and observation stage 104 may be adjusted relative to one another. The relative position of the camera 102 and light source 106 to the retro-reflective surface of the observation stage 104 may be increased or decreased through the use of optical quality mirrors or lens. This may provide an increase in the maximum size of an object that may be placed on a fixed size retro-reflective surface of the observation stage 104. Alternately the use of lens, mirrors or geometric placement of the camera may be used to reduce the amount of retro-reflective material of the observation stage 104 necessary for accurate imaging of the object.

The facets of the retro-reflective material may also be designed to direct light based on the position of the other components. Further processing of the data may also allow for various positioning and characteristics of the light source 106, camera 102, and observation stage 104. For example, additional patterns of the reflective layer, multiple cameras, or multiple light sources may be used to gather the image data. The additional processing of the image data may be used to compensate for positioning or characteristics of the reflective layer, the camera, and/or the light source.

The camera 102 and the light source 106 may provide an optical axis substantially parallel to the measurement axis of the measuring device sensor. The measuring sensor may be, for example, an ultrasonic distance sensor, which is aligned vertically near the center of the observation stage 104. The measuring sensor may be acoustical in nature or use other measuring devices known in the art. The measuring sensor may calculate the height of the object by comparing the distance between the observation stage 104 and a top surface of the object 108.

A similar sensor may be used in other directions to determine the lengths of the object in other directions. A weight sensor (not shown) may also be located under the observation stage 104. When the object is placed on the observation stage 104, the weight sensor may calculate the weight of the object by comparing the weight of the observation stage 104 and the current weight with the object placed on the observation stage 104. The additional data collected by these sensors can be processed with the other image data, discussed later herein, to determine more detailed object information.

The retro-reflective exemplary embodiment 100 may provide a crisp binary silhouette image of the object. The silhouette image data may be further processed to determine the desired attributes of the object. The system may use the silhouette image data along with the height provided by the measurement sensor to determine all three dimensions of the object. The image data and other measurement data may be processed immediately or stored for later processing. Aspects of the processing may be performed by an individual task-specific processor or by a general-purpose processor. The image data processing can be implemented in digital electronic circuitry, or in computer hardware, firmware, software, or in combinations of them.

The image data processing can be implemented as a computer program product, i.e., a computer program tangibly embodied in an information carrier, e.g., in a machine-readable storage device or in a propagated signal, for execution by, or to control the operation of, data processing apparatus, e.g., a processing device, a computer, or multiple computers. A computer program can be written in any form of programming language, including compiled, assembled, or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

For illustration purposes, the object may be a cubic package ten inches on each side. If the package is placed exactly on the optical center of the observation stage 104, it appears as a “pin-cushioned” square, with slightly convex curved edges. With the known height of the package given by the measurement sensor, machine vision based line tools produced by Tattile's Antares software or other image processing software can be used to determine edge points, which can be analyzed and “reverse engineered” to un-do the optical pin-cushioning effect.

If the square package is translated in the Z-axis without rotation, it will appear as a 4-sided rectangle. If the rear edge of the package happens to fall exactly on the optical X-axis, it will appear straight rather than outwardly bowed like the other three sides, however it will still suffer from distortion along the X-axis, appearing slightly shorter than its “real” dimension. Again the line tools can create an arbitrary number of edge points, which can be analyzed to yield four line equations whose intersections mark the real area of the package surface. This area information, combined with the z-axis height measurement data provided by the ultrasonic sensor, yields the desired volume information.

Additional image processing may be used to decrease the measurement uncertainty using multiple images of the object. All measurements are uncertain at some level. For example, a yardstick cannot be used to measure a distance to micron accuracy. For example, in the case of a 48″ high inspection area, a 6-sigma measurement accuracy yields approximately 480 measurement units in the Z-axis. Because calculated package volume measurements incorporate Z-axis measurements, even perfect silhouette measurements in the camera's field-of-view will therefore be limited to an accuracy of one part in 480. Because the dimensional measurements of the silhouettes will have their own uncertainty, the two uncertainties will combine to create an even greater effective uncertainty.

The accuracy of the measurement can be increased by making it the average of multiple measurements from multiple images. The standard deviation of such averages of multiple measurements decreases in proportion to the square root of the number of measurements made. For example, taking one hundred measurements and using the average as a single measurement will yield a standard deviation ten times smaller than the original measurements. In the case of the package volumetric measurements, there may be time to perform at least a hundred measurements, hence yielding greatly enhanced measurement accuracy of the system.

Image processing may also be used to reduce error due to the object itself. For example, it is typical for rectangular shipped packages to bulge due to excess packaging material than the package is designed to hold. In the case of larger packages, this physical “bulge” of all surfaces of a given package can easily exceed 10 mm. Some packages, particularly small packages, may truly be square with straight edges, while larger packages tend to be over-stuffed. This “bulge variance” is unpredictable and beyond the control of the object imaging system. The image processing may use a look-up table or equations to slightly modify the calculated volume measurements based, for example, on the degree of curvature of the lines making up the perimeter of the silhouette, the size of the package, etc. For example, larger packages will have larger “bulge” than smaller packages. There may be a geometric relationship that will be derived empirically. A properly designed algorithm may be able to take a rectangular package and slide and rotate it about the inspection area, and at each location read out an identical volume measurement for the same package, even if it is tipped on its side.

Another exemplary aspect of image data processing may include converting image data collected by the camera into a grayscale image data. Yet another exemplary image data processing aspect may include removing “image noise” and smoothing the appearance of the background. The image data processing may also include removing “image noise” and smoothing the object to be observed, as well as enhancing the boundary between the observation stage and the object being observed. The smoothing operation may use a median filter or other similar morphological operator to eliminate pixel noise.

Another exemplary aspect of image data processing may include measuring the pixel coordinates of at least two points on the edge of the object being observed. The image data processing may further be capable of translating the pixel coordinates of the at least two points on the edge of the object being observed, in conjunction with the height data collected by the height sensor, into real-world dimensional coordinates. The image data processing may also use calculated real world dimensions of the object being observed, in conjunction with the weight data provided by the weight sensor, to determine a “dimensional weight” as commonly defined in the package shipment industry.

The image processing may also include an edge-detection algorithm to make the object to be observed acquire a dark appearance, regardless of the color or contrast of the object's surfaces. For example, labels, tape and similar potentially contrasting features may be filtered to prevent errors during additional image data processing. A threshold operation may be used to convert a grayscale image into a binary image, where high contrast edges appear white or some other designated color, and low contrast edges are eliminated, appearing black or some other designated color. A series of binary “dilation” operations may be applied whereby each white bright pixel expands towards its neighbors, such series being sufficiently long to substantially eliminate small areas of dark pixels. A similar series of reverse “erosion” operations may be used to cause bright areas to shrink back to their original size, and reveal the boundaries of the object to be observed in uniform high contrast. The image processing allows for subsequent edge location measurement algorithms to reliably and accurately determine points along the edge profile of the object to be observed. The various exemplary aspects of image processing described herein may be used in various combinations to provide the measurements and information on the object. As previously discussed, the various aspects of image processing may be carried out using hardwired devices, or software on a general-purpose computer, or a combination thereof. The image processing may also be carried out at the camera or at other components of the system; for example, the camera may utilize a band pass filter to only allow in the wavelengths of which the light source emits.

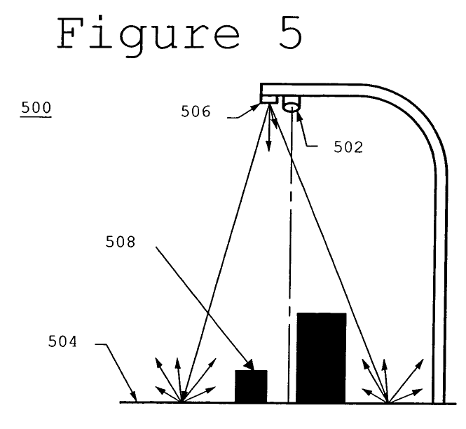

Referring to FIG. 5, a patterned observation stage exemplary embodiment 500 utilizes a consistent or known pattern to determine attributes of the object. A light source 506 reflects light off a patterned observation stage 504. A camera 502 detects the reflected light and provides an image of the pattern and the object. The image is processed to determine the edges of the object on the observation stage 504. The camera 502 may be a variety of light-detecting apparatuses known in the art. The light source 506 may be a variety of light-emitting apparatuses known in the art. The intensity of the light source and resolution of the camera may be selected based on the clarity required to determine the desired attributes of the object.

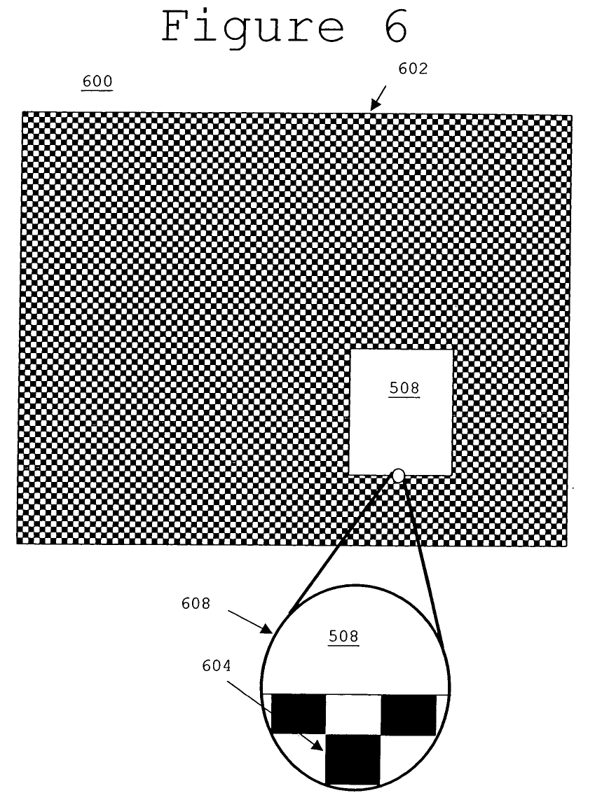

Referring to FIG. 6, an example observation stage pattern of the embodiment 600 may have a checkerboard of alternating squares 602. The dimensions of the squares 604 may be a few pixels wide or larger. Using imaging processing, the system may determine the profile of an object 508 on the observation stage by identifying edges of the pattern. An enlarged portion 608 displays the contrast between the pattern and the object 508. The system may establish points and define lines to determine the profile of the object. The system may also utilize a height sensor to determine the height and other dimensions of the object based on the determined profile. The patterned observation stage exemplary embodiment 500 may also use other image processing as previously described in other exemplary embodiments to refine the image and/or determine attributes of the object.

The patterned observation stage exemplary embodiment 500 is not limited to a checkerboard design. A variety of other repeating patterns may be used to allow the system to identify the edges of the object. The contrast between the pattern and the object allows the system to determine the edges of the object.

The present invention is not intended to be limited to a system, device, or method which must satisfy one or more of any stated or implied object or feature of the invention and is not limited to the exemplary embodiments described herein. Modifications and substitutions by one of ordinary skill in the art are considered to be within the scope of the present invention.

The invention claimed is:

1. A system for identifying an object, the system comprising:
a retro-reflective panel positioned behind the object;
a light source illuminating the retro-reflective panel and the object;
a camera imaging light reflected by the retro-reflective panel and the object; and
a microprocessor receiving the images from the camera and identifying attributes of the object.

2. The system of claim 1, wherein the attributes are a width and a depth of the object.

3. The system of claim 1, the system further comprising:
a sensor for determining a height measurement of the object.

4. The system of claim 2, wherein the system further comprises:
a sensor for determining a height measurement of the object wherein the microprocessor determines the volume of the object based on the height, the width, and the depth.

5. The system of claim 1, wherein the camera is centered over the retro-reflective panel.

6. The system of claim 1, wherein the attributes are a dimensional profile.

7. The system of claim 1, wherein a protective, translucent layer covers the retro-reflective panel.

8. The system of claim 1, wherein the light source provides near-infrared light energy.

9. The system of claim 1 wherein the microprocessor determines two or more edge points to determine a line to identify an edge of the object.

10. The system of claim 1 wherein the microprocessor performs image-processing techniques on the images.

11. The system of claim 1 wherein the camera is a video camera taking multiple images of the light reflected by the retro-reflective panel and the object; and the microprocessor utilizes the multiple images to reduce error of the identified attributes of the object.

12. A method for identifying an object, the method comprising the actions of:
reflecting light from a retro-reflective panel and an object;
imaging the light reflected by the retro-reflective panel and the object with a camera; and
identifying attributes of the object by processing the imaged light with a microprocessor.

13. The method of claim 12, wherein the attributes are a width and a depth of the object.

14. The method of claim 12, the method further comprising the actions of:
determining a height measurement of the object.

15. The method of claim 14, the method further comprising:
a sensor for determining a height measurement of the object wherein the microprocessor determines the volume of the object based on the height, the width, and the depth.

16. A system for identifying an object, the system comprising:
a patterned panel positioned behind the object;
a light source illuminating the patterned panel and the object;
a camera imaging light reflected by the retro-reflective panel and the object; and
a microprocessor receiving the images from the camera and identifying a profile of the object.

17. The system of claim 16, the system further comprising:
a sensor for determining a height measurement of the object.

18. The system of claim 16, wherein the system further comprises:
a sensor for determining a height measurement of the object wherein the microprocessor determines a width and a depth of the profile and determines the volume of the object based on the height, the width, and the depth.

19. The system of claim 16 wherein the microprocessor determines two or more edge points to determine a line to identify an edge of the object.

20. The system of claim 16 wherein the microprocessor performs image-processing techniques on the images.
